(19) United States
(12) Patent Application Publication
(10) Pub. No.: US 2012/0221617 A1
(43) Pub. Date: Aug. 30, 2012

(54) Methods and apparatus for fast matrix multiplication and fast solving of matrix equations based on generalized convolution

(76) Inventors: Muralidhara Subbarao, Stony Brook, NY (US); Shekhar Bangalore Sastry, Stony Brook, NY (US); Satyaki Dutta, New Rochelle, NY (US)

(21) Appl. No.: 13/136,566

(22) Filed: Aug. 4, 2011

Related U.S. Application Data
(60) Provisional application No. 61/463,995, filed on Feb. 25, 2011.

(51) Int. Cl. G06F 17/11; G06F 17/14; G06F 17/16; G06F 1/02

(52) U.S. Cl. 708/404; 708/420

(57) ABSTRACT

A method of fast matrix multiplication and a method and apparatus for fast solving of a matrix equation are disclosed. They are useful in many applications including image blurring, deblurring, and 3D image reconstruction, in 3D microscopy and computer vision. The methods and apparatus are based on a new theoretical result—the Generalized Convolution Theorem (GCT). Based on GCT, matrix equations that represent certain linear integral equations are first transformed to equivalent convolution integral equations through change of variables. Then the resulting convolution integral equations are evaluated or solved using the Fast Fourier Transform (FFT). Evaluating a convolution integral corresponds to matrix multiplication and solving a convolution integral equation corresponds to solving the related matrix equation through deconvolution. Carrying-out these convolution and deconvolution operations in the Fourier domain using FFT speeds up computations significantly. These results are applicable to both one-dimensional and multi-dimensional integral equations.

### RELATED PROVISIONAL APPLICATION FOR PATENT

This patent application is a continuation of the following U.S. Provisional Application for Patent filed by these inventors:
M. Subbarao, S. B. Sastry, and S. Dutta, “Methods for fast matrix multiplication and fast solving of linear matrix equations based on Fast Fourier Transform”, Provisional Application for Patent No. U.S. 61/463,995, filed Feb. 25, 2011.
   This patent application provides full details of the description of the above invention.

### FIELD OF INVENTION

This invention discloses a method of fast matrix multiplication and a method and apparatus for fast solving of a matrix equation. They are useful in deconvolution microscopy, image processing, and multiplying and inverting certain types of matrices. The methods and apparatus are based on a new theoretical result first derived and presented here—the Generalized Convolution Theorem (GCT). Based on GCT, matrix equations that represent certain linear integral equations are first transformed to equivalent convolution integral equations through change of variables. Then the resulting convolution integral equations are evaluated or solved using the Fast Fourier Transform (FFT).

### BACKGROUND

Forward and inverse filtering operations in image/signal processing can be expressed as matrix multiplication and matrix inversion operations respectively. For example see the reference below, the contents of which are incorporated herein by reference:
P. C. Hansen, J. G. Nagy, and D. P. O'Leary, “Deblurring Images: Matrices, Spectra, and Filtering”, SIAM, 2006, ISBN-10: 0898716187.
   For example, convolution is a forward filtering operation that can be expressed as matrix multiplication, and deconvolution is an inverse filtering operation related to matrix inversion. The problem of solving a linear integral equation in the continuous domain can also be expressed as solving an equivalent matrix equation in the discrete domain. In this case, a matrix inversion operation will be involved. Computationally, transition of a problem representation from continuous to discrete domain is done by discrete sampling of continuous functions, and transition from discrete to continuous domain is done through interpolation of discrete data. In this patent application, for the sake of brevity, description of the present invention refers to both the continuous and discrete domain representations interchangeably, relying on context for clarity.

Matrix representation can be used to formulate both single-variable and multi-variable/multi-dimensional signal filtering operations as well as integral equations. Sometimes this involves rearranging signal data, such as stacking columns of an image vertically in order to create a large single column vector. Matrix representation can also be used to represent both shift-variant and shift-invariant operations. Shift-invariant operations such as convolution and deconvolution can be carried-out efficiently using the Fast Fourier Transform algorithm. However shift-variant operations such as spatially-variant image blurring/deblurring correspond to general matrix multiplication and matrix inversion operations. Therefore, these shift-variant operations are often computationally exorbitant.

The present invention relates to certain matrix multiplications and the solving of certain matrix equations that are equivalent to general shift-variant signal filtering or the corresponding general linear integral equations. Fast methods and an apparatus are presented to implement solutions to such problems. This is achieved by converting shift-variant operations to equivalent shift-invariant operations through change of variables so that the Fast Fourier Transform (FFT) algorithm becomes applicable in implementing the operations.

### 2.1 Theoretical Basis of the Present Invention

Generalized Convolution Theorem (GCT) is a new theoretical result first presented here. It states that certain linear integral equations can be transformed into equivalent convolution integral equations through change of variables. Therefore, corresponding matrix multiplication problems and linear matrix equations can be converted to convolution equations. This facilitates the use of the Fast Fourier Transform (FFT) algorithm for fast matrix multiplication and fast solving of linear matrix equations. This approach to solving a matrix equation based on GCT and FFT is much faster than the prevailing methods. GCT is applicable to both one-dimensional (one-variable) and multi-dimensional (multi-variable) integral equations. Applications of this result include image processing and computer vision, e.g. shift-variant image blurring/deblurring, and computing the integral and the solving of certain linear integral equations. Application and computational advantage of GCT to deconvolution microscopy has been verified through experiments by the authors of this invention. These results will be made public after this patent application becomes public.

As the present invention is based on a completely new theory, the theory will be presented and proved here. Fortunately, the new theory is simple and requires only a background in basic differential and integral calculus to understand and verify. This theory will be presented next.

A linear integral equation of the type

g(x)=∫ₐ^{b}h(x,t)f(t)dt for a≦x,t≦b (1)

arises frequently in many applications such as image processing. The above equation in the continuous domain is often expressed in the discrete domain for numerical computations as

$$g ( x ) = {\sum }_{t = a}^{b} h ( x , t ) f ( t ) \qquad ( 2 )$$

where, for simplicity, the units of t have been scaled appropriately to take on integer values. The above equation is a matrix equation where h(x,t) is an M×N matrix and f(t) and g(x) are N×1 and M×1 matrices with M>=N. Computing g(x) at each x given h(x,t) and f(t) at each x and t involves multiplying the matrices h(x,t) and f(t) where x and t represent indices of elements in the matrices. This involves O(MN) operations. For simplicity of discussion, assume M=N. In this case, solving the matrix equation to obtain f(t) given g(x) and h(x,t) involves inverting the N×N matrix h(x,t) which is an O(N³) operation. However, in the continuous domain, if the kernel h(x,t) can be expressed in the form h(x,t)=k(y−u) for some invertible change of variables where x and t are changed with y and u respectively, then, according to the Generalized Convolution Theorem (GCT) presented here, significant computational savings can be achieved in computing g(x) from h(x,t) and f(t), as well as in solving for f(t) given h(x,t) and g(x). Such computational savings can be achieved when the variables in the equations are scalars (one-dimensional case) or vectors (multi-dimensional case). GCT is presented next for the one-dimensional case.

### Definition: Generalized Convolution (GC): One-Dimensional Case

The integral in Eq. (1) is said to be a Generalized Convolution (GC) of a function f(t) and a kernel h(x,t) when the kernel can be expressed in the form

h(x,t)=k(s(x)−r(t)) (3)

for some functions k(·), s(x) and r(t), where s(x) and r(t) are invertible. In this case, change of variables can be used to transform the integral in Eq. (1) above to a convolution integral.

### Generalized Convolution Theorem (GCT):

Let the generalized convolution of a function f(t) and a kernel h(x,t) be defined by Eqns. (1) and (3). Then, the following convolution equation can be derived from Eq. (1):

e(y)=∫_{c}^{d}k(y−u)q(u)du (4)

where (note: “≡” below means “by definition”):

$$\begin{matrix}y ≡ s ( x ) & ( 5 ) \\ u ≡ r ( t ) & ( 6 ) \\ e ( y ) ≡ g ( x ) , & ( 7 ) \\ c ≡ u ( a ) & ( 8 ) \\ d ≡ u ( b ) & ( 9 ) \\ w ( y ) ≡ x & ( 10 ) \\ v ( u ) ≡ t . & ( 11 ) \\ p ( u ) ≡ f ( t ) , & ( 12 ) \\ q ( u ) ≡ p ( u ) \frac{d v ( u )}{d u} = p ( u ) {v}^{′} ( u ) & ( 13 )\end{matrix}$$

Note that

$$d t = \frac{d v ( u )}{d u} d u ≡ {v}^{′} ( u ) d u = J ( u ) d u . \\ ( J ( u ) = {v}^{′} ( u ) is the Jacobian ) \qquad ( 14 )$$

g(x)=e(s(x)), (1 5) (From Eq. 7 and Eq. 5)

f(t)=p(r(t)) (16) (From Eq. 12 and Eq. 6)

Proof: Considering Eq. (1), we obtain

e(y)=∫ₐ^{b}k(y−u)p(u)d(v(u)) (17) (From 1, 7, 3, 5, 6, 11, 12)

e(y)=∫_{c}^{d}k(y−u)p(u)v′(u)du (18) (From 11, 14, 8, 9)

e(y)=∫_{c}^{d}k(y−u)q(u)du (19) (From 13)

Hence the theorem is proved.

Consider solving Eq. (19) which is a convolution equation. If the support domain of k is not localized but spread out to a relatively large interval in the interval of integration, then the above convolution/deconvolution can be carried-out efficiently in the Fourier domain. One may also use an iterative technique in the spatial domain to solve for q in the above equation. In the spatial domain, if the support domain of k is localized, then the Spatial-domain convolution/deconvolution transform (S Transform) can be used to compute e and then compute g from e. S Transform is described in the following reference, the contents of which are incorporated herein by reference:
M. Subbarao, T. Wei, and G. Surya, “Focused Image Recovery from Two Defocused Images Recorded with Different Camera Settings,” IEEE Transactions on Image Processing , Vol. 4, No. 12, December 1995.

S Transform can also be used for deconvolution to compute q given k and e. In the Fourier domain, discrete convolution becomes multiplication. Therefore, denoting Fourier Transforms by respective upper case letters, and frequency parameter by ω, the discrete equivalent of the convolution equation above becomes multiplication:

E(ω)=K(ω) Q(ω) (20)

which provides the solution

Q(ω)=E(ω)/K(ω). (21)

In practice, a regularization filter such as a Weiner filter may be used for the inverse filter instead of 1/K(ω). By taking the inverse Fourier transform of Q(ω) we get q(u). Then the solution for f(t) is given by

p(u)=q(u)/v′(u) (22) (From 13)

and

f(t)=p(r(t)). (23) (From 12 and 6).

In the discrete domain, we consider discretely sampled functions corresponding to each of the continuous functions above, both in the original domain and in the Fourier domain. If the sampling period is sufficiently small, the discretely sampled functions can be used to represent the continuous functions and equations to a close approximation. Therefore GCT in this case can be used to both multiply discretely sampled matrices h(x,t) and f(t), as well as to solve the linear matrix equation in Eq. (2) for f(t) using FFT. In the discrete case, convolution is interpreted as circular convolution. Some simple examples of kernel functions which satisfy conditions for the GCT are presented below.

Example: One case relevant to deconvolution microscopy is presented here.

h(x,t)=k₁(x/t)≡k(ln(x/t))=k(lnx−lnt)≡k(y−u) (25)

y=ln x=s(x) (26)

x=e^{y} (27)

u=lnt=r(t) (28)

t=e^{u}=v(u) (29)

p(u)=f(t)=p(lnt) (30)

q(u)=p(u)v′(u)=p(u)e^{u} (31)

c≡r(a)=lna (32)

d≡r(b)=lnb (33)

e(y)=e(lnx)≡g(x) (34)

Therefore, according to GCT, we obtain Eq. (19).

This example can be extended to the more general case where

h(x, t)=k₁(z₁(x)/z₂(t))=k(ln(z₁(x)/z₂(t)))=k(lnz₁(x)−lnz₂(t))≡k(y−u) (35)

This example also includes the case where

h(x,t)=k₁(xt)≡k(ln(xt))=k(lnx+lnt)=k(lnx−(−lnt))≡k(y−u) (36)

and

h(x,t)≡k(1/x−1/t)≡k(y−u). (37)

### 2.1.1 Multi Dimensional GCT

In this section, GCT will be extended to the multi-dimensional case where x and t above will correspond to multi-dimensional vectors or multi-variable functions.

### Generalized Convolution (GC) in the Multi-Dimensional Case

The following notation will be used in the subsequent discussion. A vector such as X with n components will be denoted by x=(x₁, x₂, . . . , xₙ). Vectors a, b, t, y, and u, will be used in the following discussion.

T={t/aᵢ≦tᵢ≦bᵢ for i=1 . . . n.} (38)

dT=dt₁ dt₂ . . . dtₙ (39)

Given

aᵢ≦xᵢ≦bᵢ and aᵢ≦tᵢ≦bᵢ for i=1 . . . n. (40)

Using the above notation, the integral equation

g(x₁, x₂, . . . , xₙ)=∫ₐ_{₁}^{b}^{₁} ∫ₐ_{₂}^{b}^{₂} . . . ∫ₐ_{ₙ}^{b}^{ₙ} h(x₁, x₂, . . . , xₙ, t₁, t₂, . . . , tₙ)f(t₁, t₂, . . . , tₙ)dt₁ dt₂ . . . dtₙ (41)

can be expressed as

g(x)=∫_{T} h(x, t) f(t) dT. (42)

GCT is stated and proved for the multi-dimensional case below.

Definition: The integral in Eq. (42) is said to be a (multi-dimensional) Generalized Convolution (GC) of a function f(t) and a kernel h(x,t) when the kernel can be expressed in the form

h(x,t)=k(y₁−u₁, y₂−u₂, . . . , yₙ−uₙ)=k(y−u) (43)

for some functions k(·), and for i=1, 2, . . . , n,

yᵢ=sᵢ(x) (44)

and

uᵢ=rᵢ(t), (45)

where sᵢ(x)and rᵢ(x) are invertible, i.e. there exist functions wᵢ(y) and vᵢ(u) such that

xᵢ=wᵢ(y) (46)

and

tᵢ=vᵢ(u) (47)

where the functions wᵢ(y) and vᵢ(u) are continuous, differentiable, and defined on U where

cᵢ=rᵢ(a), dᵢ=rᵢ(b), cᵢ≦uᵢ≦dᵢ (48)

U={u/cᵢ≦uᵢ≦dᵢ for i=1 . . . n.} (49)

### Generalized Convolution Theorem (GCT): Multi-Dimensional Case

If, and only if, the generalized convolution of a function f(t) and a kernel h(x,t) is defined by Eqns. (42) and (43), then, the following convolution equation can be derived from Eq. (42):

$$\begin{matrix}e ( y ) = {\int }_{U} k ( y - u ) q ( u ) d U \\ where , & ( 50 ) \\ d U = d {u}_{1} d {u}_{2} … d {u}_{n} & ( 51 ) \\ f ( t ) = f ( {v}_{1} ( u ) , {v}_{2} ( u ) , … , {v}_{n} ( u ) ) = p ( {u}_{1} , {u}_{2} , … , {u}_{n} ) = p ( u ) & ( 52 ) \\ e ( {y}_{1} , {y}_{2} , … {y}_{n} ) = e ( y ) = g ( {w}_{1} ( y ) , {w}_{2} ( y ) , … , {w}_{n} ( y ) ) & ( 53 ) \\ q ( u ) = p ( u ) J ( u ) \\ and & ( 54 ) \\ J ( u ) = ( \frac{\partial {v}_{i}}{\partial {u}_{j}} ) , ( determinant of Jacobian matrix ) & ( 55 )\end{matrix}$$

Proof:

### Proof of If Part:

By change of variables where x is changed to y and t is changed to u, we have:

g(w₁(y), w₂(y), . . . wₙ(y))=∫_{U} h(w₁(y), w₂(y), . . . wₙ(y), v₁(u), v₂(u), . . . vₙ(u)) f(v₁(u), v₂(u), . . . vₙ(u)) J(u) dU (56)

Justification for the above change of variables can be found in any standard reference book on Differential and Integral calculus, including the following, the contents of which are incorporated herein by reference:
J. E. Marsden and A. J. Tromba, Vector Calculus, 3rd Edition, Page 378, W. H. Freeman and Co., 1988, ISBN 0-7167-1856-1.
   By assumption,

h(w₁(y), w₂(y), . . . wₙ(y), v₁(u), v₂(u), . . . vₙ(u))=h(x,t)=k(y₁−u₁, y₂−u₂, . . . , yₙ−uₙ)=k(y−u) (57)

and from Eq. (52), Eq. (53), Eq. (54), we obtain

e(y)=g(w₁(y), w₂(y), . . . wₙ(y))=∫_{U} k(y−u) p(u) J(u) dU (58)

Eq. (50) follows from above.

Proof of “Only If” part:

From Eq. (56) and assumption in Eq. (58) we obtain

g(w₁(y), w₂(y), . . . wₙ(y))=∫_{U} k(y₁−u₁, y₂−u₂, . . . , yₙ−uₙ) f(v₁(u), v₂(u), . . . vₙ(u)) J(u) dU (59)

The above equation and Eq. (58) must hold for all possible or arbitrary f(·). Therefore, Eq. (57) must be true. Hence the theorem.

GCT can be applied to linear integral equations such as Fredholm's and Volterra's First and Second Kind Equations by rearranging some terms in the equations. Forward computation of the terms under the integrals can be computed efficiently using GCT. Also, the equations can be solved efficiently using GCT through deconvolution based on FFT.

### 2.1.2 Three-Dimensional (3D) Image Reconstruction

In computer vision and 3D microscopy (e.g. 3D deconvolution microscopy), a stack of 2D images are captured at different focal settings and the images are processed to reconstruct a 3D model of objects. An introduction to Deconvolution Microscopy and the problem of depth-variant point spread function that causes shift-variant blurring can be found in the following references the contents of which are incorporated herein by reference:
1. McNally, J. G., T. Karpova, et al. (1999). “Three-Dimensional Imaging by Deconvolution Microscopy.” Methods 19(3): 373-385.
2. Preza, C. and J.-A. Conchello “Depth-variant maximum-likelihood restoration for three-dimensional fluorescence microscopy.” J. Opt. Soc. Am. A 21(9): 1593-1601 (2004).
3. Gu, Min, “Three-dimensional space-invariant point-spread function for a single lens”, Vol. 12, No. 7, July 1995, Journal of the Optical Society of America, pp. 1602-1604.

The fast matrix multiplication method presented here can be used to efficiently compute the stack of images captured by an imaging system. More importantly, given a stack of 2D images captured at different focal settings, the method of fast solving of a matrix equation presented here can be used for accurate reconstruction of 3D object models. In 3D microscopy, this problem is typically solved by a piecewise convolution approximation whereas, in the present invention, no such approximation is used. The original problem is changed to an exact convolution problem through a change of variable. This solution is described below.

For simplicity, consider a thin lens image forming system shown in FIG. 3. Here, an object point P is at a distance z₀ from the lens. P has its focused image at p′ at a distance t₃. The image of P on the image detector at a distance x₃ from the lens is a blur circle of radius R with its center at the point p″. The diameter of the lens is D and the focal length is F. Therefore, according to lens formula,

1/F=1/z₀+1/t₃. (61)

Further, using the property of similar triangles in FIG. 3, we obtain

2R /D=(x₃−t₃)/t₃ (62)

Therefore,

R=D(x₃/t₃−1). (63)

The 3D point spread function (PSF) is depth-variant (i.e. it changes along the optical axis or t₃) and it is given by

$$h ( x , t ) = \{ \begin{matrix}1 / ( π {R}^{2} ) & for {( {x}_{1} - {t}_{1} )}^{2} + {( {x}_{2} - {t}_{2} )}^{2} \leq {R}^{2} \\ 0 & otherwise .\end{matrix} \qquad ( 64 )$$

where x=(x₁, x₂, x₃) and t=(t₁, t₂, t₃).
It can also be expressed as

$$h ( x , t ) = \{ \begin{matrix}1 / ( π {{D}^{2} ( {x}_{3} / {t}_{3} - 1 )}^{2} ) & for {( {x}_{1} - {t}_{1} )}^{2} + {( {x}_{2} - {t}_{2} )}^{2} \leq {{D}^{2} ( {x}_{3} / {t}_{3} - 1 )}^{2} \\ 0 & otherwise .\end{matrix} \qquad ( 65 ) .$$

A stack of 2D images captured at different axial positions x₃ can be denoted by g(x)=g(x₁, x₂, x₃) and given by

g(x)=∫_{T} h(x,t) f(t) dT. (66)

where dT=dt₁ dt₂ dt₃ and T={t/aᵢ≦tᵢ≦bᵢ for i=1,2,3}.
Due to the special structure of the kernel h(x,t) we can apply the following change of variables:

y₁=x₁, y₂=x₂, y₃=lnx₃, x₃=exp(y₃) (67)

and

u₁=t₁, u₂=t₂, u₃=lnt₃, t₃=exp(u₃) (68)

and compute the new domain U corresponding to T:

U={u/c₁=a₁≦u₁≦d₁=b₁, c₂=a₂≦u₂≦d₂=b₂, c₃=lna₃≦u₃≦d₃=lnb₃}. (69)

Define the new kernel

$$k ( y - u ) = h ( x , t ) = \{ \begin{matrix}1 / ( π {D}^{2} ( {( exp ( {y}_{3} - {u}_{3} ) - 1 )}^{2} ) & for {( {y}_{1} - {u}_{1} )}^{2} + {( {y}_{2} - {u}_{2} )}^{2} \leq {{D}^{2} ( exp ( {y}_{3} - {u}_{3} ) - 1 )}^{2} \\ 0 & otherwise .\end{matrix} \qquad ( 70 )$$

Now we obtain the convolution equation from Eq. (66) as

e(y)=∫_{U} k(y−u) p(u) J(u) dU (71)

where e(y)=g(x), p(u)=f(t), and the Jacobian J(u) for the given change of variables is J(u)=exp(u₃). Therefore, it is possible to use this convolution equation to perform both convolution and deconvolution operations using FFT. Therefore, given h(x,t) and f(t), it is possible to compute g(x) accurately and efficiently. More importantly, given g(x) and h(x,t), it is possible to solve for f(t) accurately and efficiently using FFT.

In the example above, the kernel h(x,t) was a function of x₃/t₃ and it was possible to convert it into a convolution equation. This kernel was derived based on paraxial geometric optics which is a good approximation to the actual wave optics model. In the wave optics model of image formation, it is found that h(x,t) is a function of (1/x₃−1/t₃), for example, see the following reference, the contents of which are incorporated herein by reference:
J. W. Goodman, Introduction to Fourier Optics, Second Edition, McGraw-Hill, 1996, ISBN 0-07-024254-2, Eqns. 6.38 to 6.41, page 148, Section 6.4.4.
   In this case also, the integral equation Eq. (66) can be converted to a convolution equation Eq. (71) using the change of variables

y₁=x₁, y₂=x₂, y₃=1/x₃, x₃=1/y₃ (72)

and

u₁=t₁, u₂=t₂, u₃=1/t₃, t₃=1/u₃. (73)

Therefore, the present invention is also applicable to the more accurate image formation model based on wave optics. In other words, the present invention is also applicable to point spread functions and optical imaging systems which are modeled by wave optics.

### OBJECTS AND ADVANTAGES OF THE INVENTION

It is an object of the present invention to provide an accurate method of matrix multiplication corresponding to Eq. (66) (or Eq. (42)) given h(x,t) and f(t) without approximating Eq. (66) as piecewise convolution operation found in prior art (such as in the reference cited earlier by Preza et al). This is accomplished through change of variables and converting the original problem to exact convolution as in equation Eq. (71) (or Eq. (50)) instead of an approximation. This yields more accurate results than prior art since piecewise convolution approximation of Eq. (66) used in prior art is avoided. This advantage is particularly notable in 3D microscopy where g(x) and f(t) are images and h(x,t) is the point spread function (PSF) of a microscope.

It is another object of the present invention to provide a fast method of matrix multiplication corresponding to Eq. (66) given h(x,t) and f(t) without implementing Eq. (66) directly, but by implementing it indirectly. The original problem in Eq. (66) is converted to an equivalent convolution operation as in Eq. (71) through change of variables. This facilitates the use of Fast Fourier Transform to compute the desired matrix multiplication very fast. This advantage is particularly important in 3D microscopy where g(x) and f(t) represent image data and h(x,t) represents the shift-variant PSF of a microscope.

It should be noted that the method of fast matrix multiplication of the present invention is different, much simpler, and addresses a different class of problems than the method disclosed in the following patent, the contents of which are incorporated herein by reference:
Cohn, H. L., Szegedy, B., and Umans, C. M., “Group algebra techniques for operating on matrices”, U.S. Pat. No. 7,792,894 B1, Sep. 7, 2010.

The class of problems addressed by the above invention is restricted to matrices that when represented in a group algebra based on a mathematical group, they must satisfy a Triple Product Property or the Simultaneous Triple Product Property. Further, the matrices must be represented as a formal sum. This invention in U.S. Pat. No. 7,792,894 does not address image processing applications. The present invention provides a simpler and faster method for matrix multiplication to a class of problems that is not relevant to the invention in U.S. Pat. No. 7,792,894. Also, the method and apparatus of the present invention for fast solving of a matrix equation is out of the scope of the invention in U.S. Pat. No. 7,792,894. Further, the present invention solves an important and longstanding problem in 3D microscopy and image processing by providing a fast deconvolution method and apparatus for 3D image data, whereas, once again, this problem is out of the scope of the invention in U.S. Pat. No. 7,792,894.

Another object of the present invention is to provide an accurate method of solving a matrix equation corresponding to Eq. (66) given h(x,t) and g(x). An accurate solution is computed for f(t) without approximating Eq. (66) as a piecewise convolution operation found in prior art. This is accomplished through change of variables and converting the original problem to exact convolution as in equation (71) instead of an approximation. The resulting equation is deconvolved using the Fast Fourier Transform. This yields more accurate results than prior art based on piecewise convolution approximation to model Eq. (66). This advantage exists when this method is applied to 3D microscopy where g(x) represents the blurred image, h(x,t) represents the shift-variant PSF, and the solution f(t) represents the 3D focused image.

Another object of the present invention is to provide a fast method of solving a matrix equation corresponding to Eq. (66) given h(x,t) and g(x). A fast solution is computed for f(t) without directly solving Eq. (66). This is accomplished through change of variables and converting the original problem to exact convolution as in equation (71) and implementing it. The resulting equation is deconvolved using the Fast Fourier Transform. This reduces computation substantially. This advantage exists when this method is applied to 3D microscopy where g(x) represents the blurred image, h(x,t) represents the shift-variant PSF, and the solution f(t) represents the 3D focused image.

Another object of the present invention is to provide an apparatus for accurate solving of a matrix equation corresponding to Eq. (66) given h(x,t) and g(x). An accurate solution is computed for f(t) without approximating Eq. (66) as a piecewise convolution operation found in prior art. This is accomplished through change of variables and converting the original problem to exact convolution as in equation (71) instead of an approximation. The resulting equation is deconvolved using the Fast Fourier Transform. This yields more accurate results than prior art based on piecewise convolution approximation to model Eq. (66). This advantage exists when this apparatus is used in 3D microscopy where g(x) represents the blurred image, h(x,t) represents the shift-variant PSF, and the solution f(t) represents the 3D focused image.

Another object of the present invention is to provide an apparatus for fast solving of a matrix equation corresponding to Eq. (66) given h(x,t) and g(x). A fast solution is computed for f(t) without directly solving Eq. (66). This is accomplished through change of variables and converting the original problem to exact convolution as in equation (71) and implementing it in the apparatus. The resulting equation is deconvolved using the Fast Fourier Transform. This reduces computation substantially. This advantage exists when this apparatus is used in 3D microscopy where g(x) represents the blurred image, h(x,t) represents the shift-variant PSF, and the solution f(t) represents the 3D focused image.

Further objects and advantages of the present invention will become evident to persons skilled in the art in the following description of the invention.

### SUMMARY OF THE INVENTION

The present invention discloses a method of fast matrix multiplication and a method and apparatus for fast solving of a matrix equation. This invention is useful in many applications including image blurring and deblurring in 3D microscopy. The methods and apparatus are based on the a novel theoretical result—the Generalized Convolution Theorem (GCT). Based on GCT, matrix equations that represent certain linear integral equations are first transformed to equivalent convolution integral equations through change of variables. Then the resulting convolution integral equations are evaluated or solved using the Fast Fourier Transform (FFT). Evaluating a convolution integral corresponds to matrix multiplication and solving a convolution integral equation corresponds to solving the related matrix equation through deconvolution. Carrying-out these convolution and deconvolution operations in the Fourier domain using FFT speeds up computations significantly. These results are applicable to both one-dimensional and multi-dimensional integral equations. The apparatus of the present invention includes means for implementing the different steps in the method for fast solving of a matrix equation. Computational steps in the methods of the present invention are summarized below. The notation used below is the same as in Section 2.

### 3.1 Computational Steps for Fast Matrix Multiplication Method

Implement the matrix multiplication operation

$$g ( x ) = {\sum }_{t ∈ T} h ( x , t ) f ( t ) for x , t ∈ T \qquad ( 74 )$$

which is a discrete representation of the corresponding continuous domain integral equation

g(x)=∫_{T}h(x,t) f(t) dT. (75)

The following steps are used.
1. Read f (t) and h(x,t) for all x,t ∈ T. Goal is to compute g(x) efficiently.
2. Compute change of variable functions

yᵢ=sᵢ(x), uᵢ=rᵢ(t), xᵢ=wᵢ(y) and tᵢ=vᵢ(y) for i =1, 2, . . . , n, (76)

and compute the new domain

U={u/cᵢ=rᵢ(a)≦uᵢ≦dᵢ=sᵢ(b) for i=1 . . . n}. (77)
3. Compute

p(u)=f(t), (78)

compute the Jacobian J(u), and a function

$$q ( u ) = p ( u ) J ( u ) , J ( u ) = ( \frac{\partial {v}_{i}}{\partial {u}_{j}} ) , \\ ( determinant of Jacobian matrix ) . \qquad ( 79 )$$

4. Compute kernel

k(y−u)=h(x,t). (80)
5. Compute e(y) as

$$e ( y ) = {\sum }_{u ∈ U} k ( y - u ) q ( u ) for y , u ∈ U . \qquad ( 81 )$$

which is a discrete representation of the corresponding continuous domain integral equation

e(y)=∫_{U} k(y−u) q(u) dU. (82)

This computation can be done efficiently using FFT. Note that, in this computation, the functions k(·) and q(·) must be sampled uniformly at the same points. Interpolation and resampling may be needed to obtain uniform sampling.
6. Compute

g(x)=e(y) for x ∈ T and y ∈ U (83)

and output g(x).

### 3.2 Computational Steps in the Method of Fast Solving of a Matrix Equation

Solve the matrix equation

$$g ( x ) = {\sum }_{t ∈ T} h ( x , t ) f ( t ) for x , t ∈ T \qquad ( 84 )$$

which is a discrete representation of the corresponding continuous domain integral equation

g(x)=∫_{T} h(x, t) f(t) dT. (85)

Use the following computational steps:
1. Read g(x) and h(x,t) for all x,t ∈ T . Goal is to solve for f(t) efficiently.
2. Compute change of variable functions

yᵢ=sᵢ(x), uᵢ=rᵢ(t), xᵢ=wᵢ(y) and tᵢ=vᵢ(y) for i=1, 2, . . . , n, (86)

and the new domain

U={u/cᵢ=rᵢ(a)≦uᵢ≦dᵢ=sᵢ(b) for i=1 . . . n}. (87)
3. Compute kernel

k(y−u)=h(x,t). (88)
4. Compute

e(y)=g(x) for x ∈ T and y ∈ U. (89)
5. Deconvolve e(y) with respect to k(y−u) corresponding to the following convolution to obtain q(u):

$$e ( y ) = {\sum }_{u ∈ U} k ( y - u ) q ( u ) for y , u ∈ U . \qquad ( 90 )$$

which is a discrete representation of the corresponding continuous domain convolution equation

e(y)=∫_{U} k(y−u) q(u ) dU. (91)

This computation can be done efficiently using FFT. Note that, in this computation, the functions k(·) and e(·) must be sampled uniformly at the same points. Interpolation and resampling may be needed to obtain uniform sampling.
6. Compute the Jacobian J(u), and a function

$$p ( u ) = q ( u ) / J ( u ) , J ( u ) = ( \frac{\partial {v}_{i}}{\partial {u}_{j}} ) , \\ ( determinant of Jacobian matrix ) \qquad ( 92 )$$

and obtain the desired solution by computing f(t) using

f(t)=p(u) (93)

and output f(t).

### Apparatus

The apparatus of the present invention for fast solving of a matrix equation includes a means for carrying-out each of the computational steps in the above method in Section 3.2.

### BRIEF DESCRIPTION OF THE DRAWINGS

FIG. 1 shows a flow-chart of a method of the invention. It pertains to a method for fast matrix multiplication in Eq. (74) summarized in Section 3.1 earlier. Here the multiplication problem is equivalent to evaluating a linear integral equation Eq. (75). The steps in the flow chart implement the method for computing g(x) given h(x,t) and f(t).

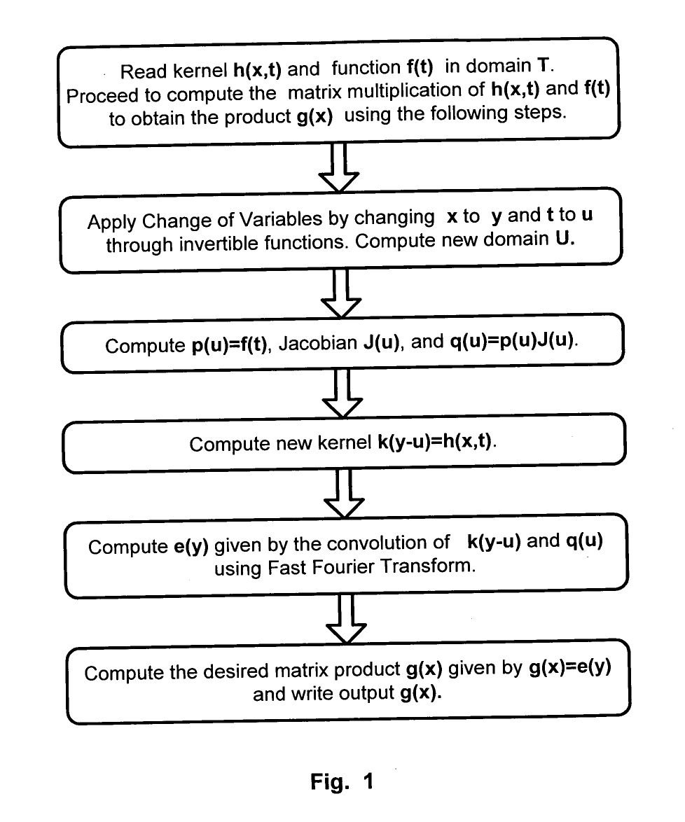

FIG. 2 shows a flow-chart of a method for fast solving of a matrix equation Eq. (84) that is equivalent to solving a linear integral equation Eq. (85). This method is the one summarized in Section 3.2. The steps in the flow-chart implement the method for computing f(t) given h(x,t) and g(x).

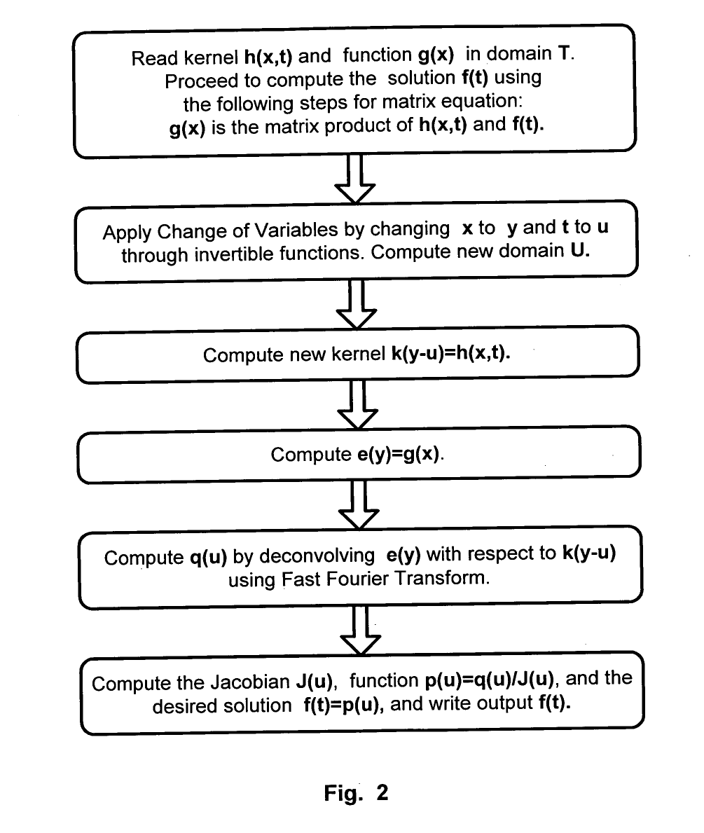

FIG. 3 shows a diagram of the image formation process in a simple optical imaging system with a thin lens. An object point P forms a focused image at p′ and a blur circle or blurred image at p″. The blur circle radius is R. The lens diameter is D and the focal length is F.

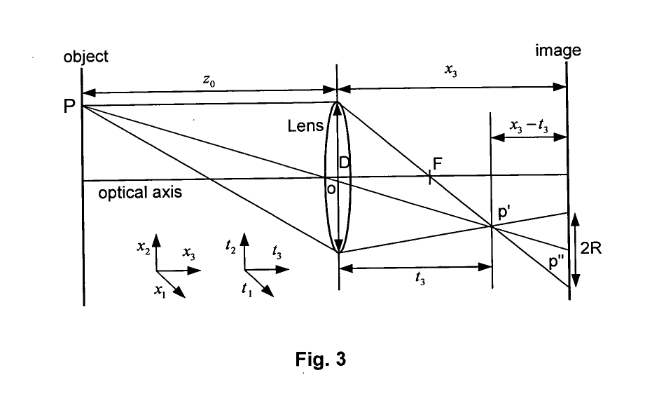

### DETAILED DESCRIPTION OF THE INVENTION

### 5.1 Method of Fast Matrix Multiplication

The present invention discloses a method of fast matrix multiplication as in Eq. (74). The cases in which it is useful are those where a matrix multiplication is equivalent to evaluating a certain linear integral equation as in Eq. (75). This method is limited to a case where the linear integral equation Eq. (75) can be transformed to an equivalent convolution integral equation Eq. (82) based on change of variables as in Eq. (76). The linear integral equation Eq. (75) has vector indices or variables x and t defined in a domain T, a kernel function h or h(x,t), a given function f or f(t), and a product function or integral g or g(x) that needs to be computed. See Section 2.1.1 for details on notation. The vector indices or variables x and t can be one-dimensional (1 D), two-dimensional (2D), three-dimensional (3D), or four or more dimensional (n-dimensional). This method comprises the following steps.

An invertible change of variable as in Eq. (76) is applied to linear integral equation Eq. (75) for variable t with another variable or index u. The new domain U corresponding to the original domain T is computed using Eq. (77).

Next a function p(u) is computed using p(u)=f(t) and the Jacobian (i.e. determinant of the Jacobian matrix) denoted by J(u) is computed. Elements of the Jacobian matrix are defined by Eq. (55). Then a function q(u) is computed as q(u)=p(u)J(u). All these computations are carried-out based on change of variable in Eq. (76).

In the next step, another invertible change of variable in the linear integral equation Eq. (75) is applied for variable x with another variable or index y. This is done according to Eq. (76). Then a new kernel function k is computed using the relation k(y−u)=h(x,t).

Next the convolution of k and q is computed using Eq. (81) to obtain e(y). Then the product function g is computed using the equation g(x)=e(y) based on the change of variable in Eq. (76). The resulting g(x) is provided as output. Convolution computation in this step can be carried-out efficiently using the Fast Fourier Transform.

The method above is applicable to the case where kernel matrix h(x,t) is the point spread function of an optical imaging device such as a microscope or a digital camera. In this case, f(t) would be the focused image and g(x) would be corresponding blurred image.

### 5.2 Method of Fast Solving of a Matrix Equation

The present invention discloses a method of fast solving of a matrix equation as in Eq. (84). The cases in which it is useful are those where solving the matrix equation is equivalent to solving a certain linear integral equation as in Eq. (85). This method is limited to a case where the linear integral equation Eq. (85) can be transformed to an equivalent convolution integral equation as in Eq. (91) based on change of variables as in Eq. (86). The linear integral equation Eq. (85) has vector indices or variables x and t defined in a domain T, a kernel function h or h(x,t), an unknown function f or f(t) that needs to be solved for or determined, and a known or given function or integral g or g(x). See Section 2.1.1 for details on notation. In this method, f(t) needs to be determined given the kernel h(x,t) and the function g(x). The vector indices or variables x and t can be one-dimensional (1D), two-dimensional (2D), three-dimensional (3D), or four or more dimensional (n-dimensional). This method comprises the following steps.

An invertible change of variable is applied to the linear integral equation Eq. (85) for variable t with another variable or index u as in Eq. (86). The new domain U corresponding to the original domain T is computed using Eq. (87).

Another invertible change of variable is applied to the linear integral equation Eq. (85) for variable x with another variable or index y as in Eq. (86). A kernel function k specified by k(y−u)=h(x,t) is computed based on the change of variables t, x, with u, y, respectively as in Eq. (86).

Next the function e is computed using the equation e(y)=g(x) based on the change of variable of x with y in Eq. (86). Then the deconvolution of e(y) with respect to kernel k is computed using Eq. (90) to obtain the function q(u). Deconvolution computation in this step can be carried-out efficiently using the Fast Fourier Transform. Further, this deconvolution step can be carried-out using a regularization technique to reduce the effects of noise. One such regularization method is to use a Weiner filter or a spectral filter based on Singular Value Decomposition.

Next the jacobian j(u) corresponding to change of variables in Eq. (86) is computed and the function p(u) is computed using p(u)=q(u)/J(u). Then the desired solution is obtained by computing the unknown function f(t) using f(t)=p(u) based on change of variables in Eq. (86). The resulting function f(t) is provided as output.

The method above is applicable to the case where the kernel matrix h(x,t) is the point spread function of an optical imaging device such as a microscope or a digital camera. In this case, f(t) would be the focused image and g(x) would be the corresponding blurred image.

### 5.3 Apparatus for Fast Solving of a Matrix Equation

The present invention discloses an apparatus for fast solving of a matrix equation as in Eq. (84). This apparatus is useful in certain limited cases. The cases in which it is useful are those where solving the given matrix equation Eq. (84) is equivalent to solving a certain linear integral equation as in Eq. (85). This apparatus is limited to a case where the linear integral equation Eq. (85) can be transformed to an equivalent convolution integral equation as in Eq. (91) based on change of variables as in Eq. (86).

The linear integral equation Eq. (85) has vector indices or variables x and t defined in a domain T, a kernel function h or h(x,t) that is given, an unknown function f or f(t) that needs to be solved for or determined, and a known or given function or integral g or g(x). See Section 2.1.1 for details on notation. In this apparatus, f(t) will be determined given the kernel h(x,t) and the function g(x). The vector indices or variables x and t can be one-dimensional (1D), two-dimensional (2D), three-dimensional (3D), or four or more dimensional (n-dimensional). This apparatus comprises the following means. In this description, means for computing different functions can be understood as a computer storage medium containing computer executable instructions wherein the storage medium is operatively connected to a computer processing unit that can carry-out the stored instructions. Examples of this are personal computers, server computers, and computers in the cloud computing technology.

The apparatus includes a means for applying an invertible change of variable in the linear integral equation Eq. (85) for variable t with another variable or index u as in Eq. (86). It also includes a means for computing a new domain U corresponding to the original domain T using Eq. (87).

The apparatus also includes a means for applying an invertible change of variable in the linear integral equation Eq. (85) for variable x with another variable or index y as in Eq. (86). It also includes a means for computing a kernel function k specified by k(y−u)=h(x,t) based on the change of variables t, x, with u, y, respectively, as in Eq. (86).

The apparatus further includes a means for computing the function e using the equation e(y)=g(x) based on the change of variable of x with y in Eq. (86).

The apparatus further includes a means for computing the deconvolution of e(y) with respect to kernel k using Eq. (90) and obtain a function q(u). This means for deconvolution may be based on Fast Fourier Transform. This means may further include a means to carry-out the deconvolution based on a regularization technique to reduce the effects of noise. One such regularization technique is the Weiner filter or a spectral filter based on Singular Value Decomposition.

The apparatus also includes a means for computing the Jacobian J(u) corresponding to change of variables in Eq. (86), computing the function p(u) using the equation p(u)=q(u)/J(u).), and obtaining desired solution by computing the unknown function f(t) using f(t)=p(u) based on change of variables in Eq. (86), and a means for providing the resulting f(t) as output.

The apparatus above may further include an optical imaging device whose point spread function is the kernel matrix h(x,t).

### CONCLUSION

The present invention provides a novel method for fast matrix multiplication and a method and apparatus for fast solving of a matrix equation in certain cases. While the description here of the methods, apparatus, and applications contain many specificities, these should not be construed as limitations on the scope of the invention, but rather as exemplifications of preferred embodiments thereof. Further modifications and extensions of the present invention herein disclosed will occur to persons skilled in the art to which the present invention pertains, and all such modifications are deemed to be within the scope and spirit of the present invention as defined by the appended claims and their legal equivalents thereof.

What is claimed is:

1. A method of fast matrix multiplication that is equivalent to evaluating a linear integral equation, said method limited to a case where said linear integral equation can be transformed to an equivalent convolution integral equation based on change of variables, said linear integral equation having vector indices or variables x and t defined in a domain T, a kernel function h or h(x,t), a given function f or f(t), a product function g or g(x) that needs to be computed, said linear integral equation specified by the relation that g(x) is equal to the sum or integral over the variable t in domain T of the product of h(x,t) and f(t), said method comprising the steps of:
(a) applying an invertible change of variable to said linear integral equation for variable t with another variable or index u and computing the domain U of u corresponding to said domain T;
(b) computing a function p(u) using p(u)=f(t), the Jacobian denoted by J(u), and a function q(u)=p(u)J(u), wherein all computations are based on change of variable in Step (a) ;
(c) applying an invertible change of variable in said linear integral equation for variable x with another variable or index y, and computing a kernel function k specified by k(y−u)=h(x,t) corresponding to change of variable in Step (a);
(d) computing the convolution of k obtained in Step (c) and q computed in Step (b) to obtain the resulting function e wherein the convolution operation is specified by the relation that e(y) is equal to the sum or integral over the variable u in domain U of the product of k(y−u) and q(u); and
(e) computing said product function g using the equation g(x)=e(y) based on the change of variable in Step (c).

2. The method of claim 1 wherein the convolution computation in Step (d) is carried-out using the Fast Fourier Transform algorithm.

3. The method of claim 2 wherein said kernel matrix h(x,t) is the point spread function of an optical imaging device.

4. The method of claim 1 wherein the vector variables or indices x and t are both one-dimensional vectors, each with a single component.

5. The method of claim 1 wherein the vector variables or indices x and t are both two-dimensional vectors, each with two components.

6. The method of claim 1 wherein the vector variables or indices x and t are both three-dimensional vectors, each with three components.

7. The method of claim 1 wherein the vector variables or indices x and t are both at least four-dimensional vectors, each with at least four components.

8. A method of fast solving of a matrix equation that is equivalent to solving a linear integral equation, said method limited to a case where said linear integral equation can be transformed to an equivalent convolution integral equation based on change of variables, said linear integral equation having vector indices or variables x and t defined in a domain T, a kernel function h or h(x,t), an unknown function f or f(t) which needs to be solved for or determined, a known or given function g or g(x), said linear integral equation specified by the relation that g(x) is equal to the sum or integral over the variable t in domain T of the product of h(x,t) and f(t), said method comprising the steps of:
(a) applying an invertible change of variable to said linear integral equation for variable t with another variable or index u and computing the domain U of u corresponding to said domain T;
(b) applying an invertible change of variable to said linear integral equation for variable x with another variable or index y, and computing a kernel function k specified by k(y−u)=h(x,t) corresponding to change of variable in Step (a);
(c) computing a function e using the equation e(y)=g(x) based on the change of variable in Step (b);
(d) computing the deconvolution of e(y) with respect to kernel k obtained in Step (b) to obtain a function q(u) wherein the deconvolution operation corresponds to the convolution operation specified by the relation that e(y) is equal to the sum or integral over the variable u in domain U of the product of k(y−u) and q(u); and
(e) computing the Jacobian j(u) corresponding to change of variable in Step (a), a function p(u)=q(u)/J(u), and obtaining desired solution by computing said unknown function f(t) using f(t)=p(u) based on change of variable in Step (a).

9. The method of claim 8 wherein the deconvolution computation in Step (d) is carried-out using the Fast Fourier Transform algorithm.

10. The method of claim 8 wherein the deconvolution computation in Step (d) is carried-out using a regularization technique to reduce the effects of noise.

11. The method of claim 8 wherein said kernel matrix h(x,t) is the point spread function of an optical imaging device.

12. The method of claim 8 wherein the vector variables or indices x and t are both one-dimensional vectors, each with a single component.

13. The method of claim 8 wherein the vector variables or indices x and t are both two-dimensional vectors, each with two components.

14. The method of claim 8 wherein the vector variables or indices x and t are both three-dimensional vectors, each with three components.

15. The method of claim 8 wherein the vector variables or indices x and t are both at least four-dimensional vectors, each with at least four components.

16. An apparatus for fast solving of a matrix equation that is equivalent to solving a linear integral equation, said apparatus limited to a case where said linear integral equation can be transformed to an equivalent convolution integral equation based on change of variables, said linear integral equation having vector indices or variables x and t defined in a domain T, a kernel function h or h(x,t), an unknown function f or f(t) which needs to be solved for or determined, a known or given function g or g(x), said linear integral equation specified by the relation that g(x) is equal to the sum or integral over the variable t in domain T of the product of h(x,t) and f(t), said apparatus comprising:
(a) a means for applying an invertible change of variable to said linear integral equation for variable t with another variable or index u and computing the domain U of u corresponding to said domain T;
(b) a means for applying an invertible change of variable to said linear integral equation for variable x with another variable or index y, and computing a kernel function k specified by k(y−u)=h(x,t) corresponding to change of variable in item (a);
(c) a means for computing a function e using the equation e(y)=g(x) based on the change of variable in item (b);
(d) a means for computing the deconvolution of e(y) with respect to kernel k obtained in item (b) to obtain a function q(u) wherein the deconvolution operation corresponds to the convolution operation specified by the relation that e(y) is equal to the sum or integral over the variable u in domain U of the product of k(y−u) and q(u); and
(e) a means for computing the Jacobian J(u) corresponding to change of variable in item (a), a function p(u)=q(u)/J(u), and obtaining desired solution by computing said unknown function f(t) using f(t)=p(u) based on change of variable in item (a).

17. The apparatus of claim 16 wherein the deconvolution computation means in item (d) includes a means for computing the Fast Fourier Transform.

18. The apparatus of claim 16 which further includes an optical imaging device whose point spread function is the kernel matrix h(x,t).

19. The apparatus of claim 18 wherein the vector variables or indices x and t are both three-dimensional vectors, each with three components.

20. The apparatus of claim 19 wherein the means for computing the deconvolution in item (d) includes a means for carrying-out a regularization technique to reduce the effects of noise.
